(19) United States
(12) Patent Application Publication
(10) Pub. No.: US 2010/0017723 A1
(43) Pub. Date: Jan. 21, 2010

(54) APPARATUS FOR INTRODUCING A DEPENDENCY BETWEEN A USER INTERFACE AND A SIGNAL

(75) Inventors: Elmo Marcus Attila Diederiks, Eindhoven (NL); Bartel Marinus Van De Sluis, Eindhoven (NL); Lucas Jacobus Franciscus Geurts, Eindhoven (NL); Anton Oguzhan Alford Andrews, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,141

(22) PCT Filed: Dec. 6, 2007
(86) PCT No.: PCT/IB2007/054938

§ 371 Date: Jun. 8, 2009

(30) Foreign Application Priority Data
Dec. 12, 2006 (EP) 06125854.7

(51) Int. Cl. G09G 5/00; G06F 3/00

(52) U.S. Cl. 715/744

(57) ABSTRACT

An apparatus (1) for introducing dependencies between user-interfaces (120) of devices (100) and for example audio/video signals to be rendered via the devices (100) is provided with a circuit (2,3,4) for linking values of transfer parameters of the signals and values of quality parameters of the user-interfaces (120), to increase the user-friendliness. A given first (second) transfer of the audio/video signal results in a first (second) quality of the user-interface (120), and a chosen first (second) quality of the user-interface (120) results in a first (second) transfer of the audio/video signal. The quality may be a quality of a “skin” or a “look and feel” or an input property or an output property of the user-interface (120). The transfer may be expressed in bandwidth, resolution, number of colors or grey values, sample rate, frequency characteristic and costs. The quality may be expressed in bandwidth, resolution, number of colors or grey values, sample rate, frequency characteristic and processing capacity.

### FIELD OF THE INVENTION

The invention relates to an apparatus for introducing a dependency between a user-interface of a device and a signal to be processed by the device, to a device comprising an apparatus, to a further device comprising an apparatus, to a method, to a computer program product and to a medium.

Examples of such an apparatus are consumer products and non-consumer products, examples of such a device are consumer products for rendering audio/video signals, examples of such a further device are network devices for providing audio/video signals to a device for rendering the audio/video signals, and examples of such a signal are audio/video signals. An audio/video signal is a signal comprising audio and/or video.

### BACKGROUND OF THE INVENTION

US 2002/0054086 A1 discloses in its title a method and an apparatus for adapting a graphical user interface and discloses in its paragraph 0006 skin means for changing a currently applied skin in response to an event not originating from a user request to create a more attractive apparatus and discloses in its paragraph 0010 skin means for adapting the graphical user interface in response to a content of an audio/video signal to affect a mood of a user such as a listener or a viewer.

### SUMMARY OF THE INVENTION

It is an object of the invention, inter alia, to provide an apparatus as defined above for increasing a user-friendliness of the device.

A first aspect of the invention provides an apparatus for introducing a dependency between a user-interface of a device and a signal to be processed by the device, which apparatus comprises a circuit for linking a value of a transfer parameter of the signal and a value of a quality parameter of the user-interface.

By providing the apparatus with a circuit such as a memory for linking a value (or a group of values) of a transfer parameter of the audio/video signal and a value (or a group of values) of a quality parameter of the user-interface, a link is made between a transfer characteristic of the audio/video signal and a quality characteristic of the user-interface. A first (second, third, fourth etc.) transfer characteristic of the audio/video signal may result in a selection of a first (second, third, fourth etc.) quality characteristic of the user-interface, and a first (second, third, fourth etc.) quality characteristic of the user-interface may result in a selection of a first (second, third, fourth etc.) transfer characteristic of the audio/video signal. A device comprising such a circuit has an increased user-friendliness. An interaction between such a device and a user is of a reduced complexity.

The apparatus may form part of the device, in which case the device may retrieve the audio/video signal from an internal storage medium located inside the device or an external storage medium located outside the device. The user-interface of the device may be used for rendering the audio/video signal, or alternatively a further user-interface may be used for said rendering. So, the audio/video signal is to be rendered via the device. The apparatus may alternatively form part of a further device located in a network, in which case the device may retrieve the audio/video signal from an internal storage medium located inside the device or an external storage medium located outside the device and for example located inside or near said further device. A first (second, third etc.) characteristic is for example a good (average, poor etc.) characteristic. The quality characteristic of the user-interface is for example a quality of a “skin” of the user-interface and/or of a “look and feel” of the user-interface and/or of an input property of the user-interface and/or of an output property of the user-interface.

According to an embodiment as claimed in claim 2, the circuit is provided with a detector for detecting one of the values (or one group of values) and with a generator for in response to a detection result generating the other one of the values (or the other group of values). A detection of a first (second, third etc.) transfer characteristic of the audio/video signal may result in a generation of a first (second, third etc.) quality characteristic for the user-interface, and a detection of a first (second, third etc.) quality characteristic of the user-interface may result in a generation of a first (second, third etc.) transfer characteristic for the audio/video signal.

According to an embodiment as claimed in claim 3, the circuit is provided with a converter for converting the value (or the group of values) of the transfer parameter of the signal into the value (or the group of values) of the quality parameter of the user-interface. In this case, a user of the device is automatically informed via a quality of the user-interface of the device about (a quality of) a transfer of the audio/video signal.

According to an embodiment as claimed in claim 4, for example a user of the device instructs the device to select a quality of the user-interface, and the circuit is provided with a converter for in response to an instruction converting the value (or the group of values) of the quality parameter of the user-interface into the value (or the group of values) of the transfer parameter of the signal. In this case, the user of the device adapts (a quality of) a transfer of the audio/video signal by adapting a quality of the user-interface.

According to an embodiment as claimed in claim 5, the transfer parameter of the audio/video signal corresponds with a bandwidth of, a resolution of, a number of colors in, a number of grey values in, a sample rate of, a frequency characteristic of and/or a cost parameter of the audio/video signal, and the quality parameter of the user-interface corresponds with a bandwidth of, a resolution of, a number of colors in, a number of grey values in, a sample rate of and/or a frequency characteristic of a user-interface signal of the user-interface and/or a processing capacity available for the user-interface. So, for example a relatively low number of colors in the user-interface signal tells a user that the audio/video signal is of a relatively low quality and/or that the audio/video signal is relatively low-cost, and for example a selection by the user of a relatively high processing capacity for the user-interface results in the audio/video signal being transferred at a relative high quality and/or at relatively high costs.

One or more values of a transfer parameter and/or one or more values of a quality parameter may be set by the apparatus and/or by the device and/or by a user of the device and/or by the further device and/or by an operator of the further device and independently from a location of the apparatus.

A second aspect of the invention provides a device as claimed in claim 6. A third aspect of the invention provides a method of introducing a dependency between a user-interface (120) of a device (100) and a signal to be processed by the device (100), which method comprises a step of linking a value of a transfer parameter of the signal and a value of a quality parameter of the user-interface (120).

A fourth aspect of the invention provides a computer program product as claimed in claim 8. A fifth aspect of the invention provides a medium as claimed in claim 9.

Embodiments of the device, the further device, the method, the computer program product and the medium correspond with the embodiments of the apparatus.

An insight might be, that a dependency between a user-interface of a device and a signal to be processed by the device may be used for increasing a user-friendliness of the device. A basic idea might be, that a value of a transfer parameter of the signal and a value of a quality parameter of the user-interface are to be linked.

A problem to provide an apparatus for increasing a user-friendliness of the device is solved. A further advantage of the apparatus might be, that a link between a transfer of the signal and a quality of the user-interface may be used in both directions.

These and other aspects of the invention are apparent from and will be elucidated with reference to the embodiments described hereinafter.

### BRIEF DESCRIPTION OF THE DRAWINGS

In the drawings:

FIG. 1 shows a schematic block diagram of a device according to the invention comprising a first embodiment of an apparatus according to the invention,

FIG. 2 shows a schematic block diagram of a device according to the invention comprising a second embodiment of an apparatus according to the invention,

FIG. 3 shows a schematic block diagram of a device according to the invention comprising a third embodiment of an apparatus according to the invention, and

FIG. 4 shows a schematic block diagram of a system that comprises a device, one or more networks and a further device comprising an apparatus according to the invention.

### DETAILED DESCRIPTION

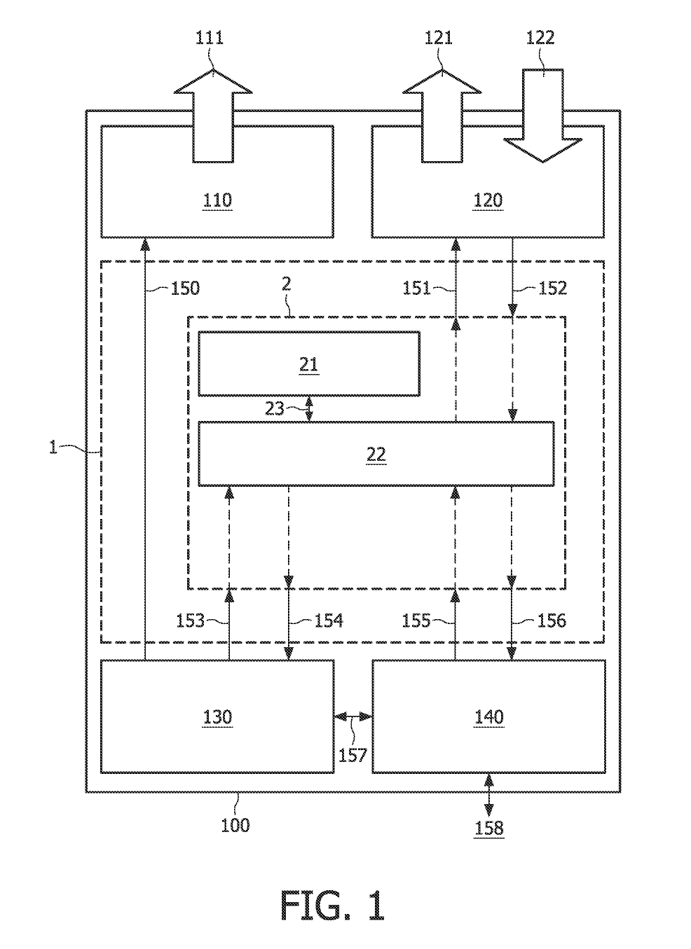

The device 100 according to the invention shown in the FIG. 1 comprises a first user-interface 110 for rendering an audio/video signal via one or more loudspeakers and/or one or more displays all represented by an arrow 111 and forming part of and/or coupled to the first user-interface 110. The device 100 further comprises a second user-interface 120 for receiving input information from a user via a keyboard, a mouse, a microphone and/or a touch-screen all represented by an arrow 121 and forming part of and/or coupled to the second user-interface 120. The second user-interface 120 further supplies output information to a user via one or more loudspeakers and/or one or more displays all represented by an arrow 122 and forming part of and/or coupled to the second user-interface 120. Instead of using two or more different user-interfaces 110,120 for rendering the audio/video signal and for receiving the input information and for supplying the output information, one user-interface may be used for these purposes.

The device 100 further comprises a storage medium 130 for storing the audio/video signal, which storage medium 130 is coupled to the first user-interface 110 via a coupling 150 for supplying the audio/video signal to the first user-interface 110. The device 100 further comprises a network-interface 140 to be coupled to a network via a coupling 158 for receiving the audio/video signal from the network. Via a coupling 157 the network-interface 140 is coupled to the storage medium 130 to supply the audio/video signal to the first user-interface 110 via the storage medium 130. Alternatively, the network-interface 140 may be coupled directly to the first user-interface 110 via the coupling 150 or via another coupling not shown. So, the audio/video signal to be rendered via the first user-interface 110 may be retrieved from the storage medium 130 or from a network coupled to the network-interface 140 possibly via the storage medium 130.

The device 100 further comprises an apparatus 1 according to the invention comprising a circuit 2. This circuit 2 comprises a memory 21 coupled to a controller 22 via a coupling 23. The controller 22 comprises a second user-interface output coupled to the second user-interface 120 via a coupling 151 and a second user-interface input coupled to the second user-interface 120 via a coupling 152. The controller 22 comprises a storage medium input coupled to the storage medium 130 via a coupling 153 and a storage medium output coupled to the storage medium 130 via a coupling 154. The controller 22 comprises a network-interface input coupled to the network-interface 140 via a coupling 155 and a network-interface output coupled to the network-interface 140 via a coupling 156.

The apparatus 1 introduces a dependency between the second user-interface 120 and the audio/video signal to be rendered via the device 100. The dependency comprises a link between a value of a transfer parameter of the audio/video signal and a value of a quality parameter of the second user-interface 120. Thereto, the circuit 2 is provided with the memory 21 for making said link. The controller 22 for example receives the value of the transfer parameter of the audio/video signal from the storage medium 130 or from the network-interface 140 and supplies this value to the memory 21. In response, the memory 21 delivers the value of the quality parameter of the second user-interface 120 to the controller 22, which supplies this value to the second user-interface 120. Alternatively and/or in addition, the controller 22 for example receives the value of the quality parameter of the second user-interface 120 from this second user-interface 120 and supplies this value to the memory 21. In response, the memory 21 delivers the value of the transfer parameter of the audio/video signal to the controller 22, which supplies this value to the storage medium 130 or to the network-interface 140.

As a result, a first (second, third, fourth etc.) transfer parameter value of the audio/video signal may result in a selection of a first (second, third, fourth etc.) quality parameter value for the second user-interface 120, and a first (second, third, fourth etc.) quality parameter value from the second user-interface 120 may result in a selection of a first (second, third, fourth etc.) transfer parameter value for the audio/video signal. The quality parameter of the user-interface for example defines a quality of (a part of) a “skin” of the user-interface and/or a “look and feel” of the user-interface and/or an input property of the user-interface and/or an output property of the user-interface.

The transfer parameter of the audio/video signal for example corresponds with a bandwidth of, a resolution of, a number of colors in, a number of grey values in, a sample rate of, a frequency characteristic of and/or a cost parameter of the audio/video signal, without excluding further options. The quality parameter of the second user-interface 120 for example corresponds with a bandwidth of, a resolution of, a number of colors in, a number of grey values in, a sample rate of and/or a frequency characteristic of a user-interface signal of the user-interface and/or a processing capacity available for the user-interface, without excluding further options. So, for example a relatively low resolution of the user-interface signal tells a user that the audio/video signal is of a relatively low quality (owing to the fact that it for example has a relatively low bandwidth or a relatively low resolution etc.) and/or that the audio/video signal is relatively low-cost (provided via a relatively low-cost network and/or provided by a provider at relatively low costs etc.). For example a selection by the user of a relatively high resolution of the second user-interface 120 results in the audio/video signal being transferred at a relative high quality (owing to the fact that it for example has a relatively high bandwidth or a relatively high resolution etc.) and/or at relatively high costs (provided via a relatively high-cost network and/or provided by a provider at relatively high costs etc.).

Instead of providing the storage medium 130 and the network-interface 140 with separate outputs for supplying the transfer parameter values to the controller 22, the controller 22 may retrieve these values from or via the couplings 150, 157 and 158. Instead of providing the storage medium 130 and the network-interface 140 with separate inputs for receiving the transfer parameter values from the controller 22, separate units may be introduced for receiving these transfer parameter values from the controller 22 and in response adjusting the transfer of the audio/video signal, for example via the coupling 150, 157 or 158. A transfer parameter value provided by the controller 22 to the network-interface 140 may be forwarded via the coupling 158 into a network for adjusting the transfer of the audio/video signal through this network and/or at a provider.

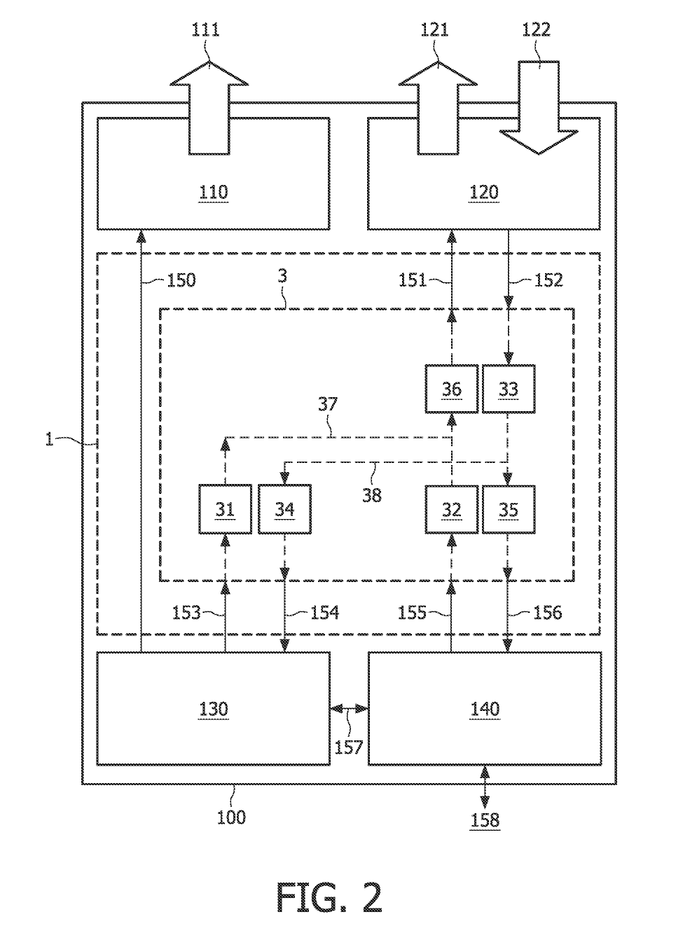

The device 100 according to the invention shown in the FIG. 2 differs from the one shown in the FIG. 1 in that the apparatus 1 comprises a circuit 3 with a first detector 31 coupled to the coupling 153, a second detector 32 coupled to the coupling 155, a third detector 33 coupled to the coupling 152, a first generator 34 coupled to the coupling 154 and further coupled to the third detector 33 via a coupling 38, a second generator 35 coupled to the coupling 156 and further coupled to the third detector 33 via the coupling 38, and a third generator 36 coupled to the coupling 151 and further coupled to the first and second detectors 31 and 32 via a coupling 37.

The detector 31 or 32 detects a value of the transfer parameter of the audio/video signal, and the detector 33 detects a value of the quality parameter of the second user-interface 120. The generator 34 or 35 generates a value of the transfer parameter for the audio//video signal in response to a detection result from the detector 33, and the generator 36 generates a value of the quality parameter for the second user-interface 120 in response to a detection result from the detector 31 or 32. So, a detection of a first (second, third etc.) transfer parameter value of the audio/video signal may result in a generation of a first (second, third etc.) quality parameter value for the user-interface, and a detection of a first (second, third etc.) quality parameter value of the second user-interface 120 may result in a generation of a first (second, third etc.) transfer parameter value for the audio/video signal.

Again, instead of providing the storage medium 130 and the network-interface 140 with separate outputs for supplying the transfer parameter values to the detectors 31 and 32, the detectors 31 and 32 may retrieve these values from or via the couplings 150, 157 and 158. Instead of providing the storage medium 130 and the network-interface 140 with separate inputs for receiving the transfer parameter values from the generators 34 and 35, separate units may be introduced for receiving these transfer parameter values from the generators 34 and 35 and in response adjusting the transfer of the audio/video signal, for example via the coupling 150, 157 or 158. A transfer parameter value provided by the generator 35 to the network-interface 140 may be forwarded via the coupling 158 into a network for adjusting the transfer of the audio/video signal through this network and/or at a provider.

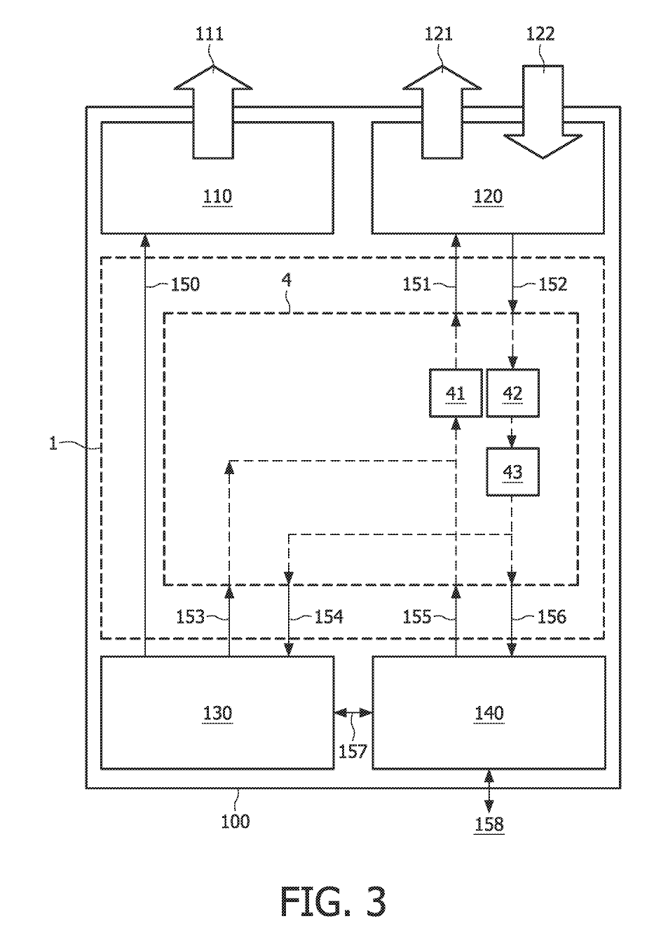

The device 100 according to the invention shown in the FIG. 3 differs from the one shown in the FIG. 1 and 2 in that the apparatus 1 comprises a circuit 4 with a first converter 41 comprising an input coupled to the couplings 153 and 155 and comprising an output coupled to the coupling 151, a selector 42 comprising an input coupled to the coupling 152, and a second converter 43 comprising an input coupled to an output of the selector 42 and comprising an output coupled to the couplings 154 and 156.

The first converter 41 converts the value of the transfer parameter of the audio/video signal into the value of the quality parameter for the second user-interface 120, for example to automatically inform a user of the device 100 via a quality of the second user-interface 120 about (a quality of) a transfer of the audio/video signal.

The selector 42 receives information from the user via the coupling 152, which may be considered to be an input of the apparatus 1 for receiving information from the user. The selector 42, in response to a reception of the information, selects the value of the quality parameter of the second user-interface 120. In case of this information already being equal to the value of the quality parameter of the second user-interface 120, the selection only comprises the forwarding of this value of the quality parameter of the second user-interface 120. Therefore, either an output of the selector 42 may be considered to be a port for receiving the value of the quality parameter of the second user-interface 120, or coupling 152 may be considered to be a port for receiving the value of the quality parameter of the second user-interface 120. The second converter 43 converts this value of the quality parameter of the second user-interface 120 into the value of the transfer parameter for the audio/video signal, for example to allow the user of the device 100 to adapt (a quality of) a transfer of the audio/video signal by adapting a quality of the second user-interface 120.

Again, instead of providing the storage medium 130 and the network-interface 140 with separate outputs for supplying the transfer parameter values to the first converter 41, the first converter 41 may retrieve these values from or via the couplings 150, 157 and 158. Instead of providing the storage medium 130 and the network-interface 140 with separate inputs for receiving the transfer parameter values from the second converter 43, separate units may be introduced for receiving these transfer parameter values from the second converter 43 and in response adjusting the transfer of the audio/video signal, for example via the coupling 150, 157 or 158. A transfer parameter value provided by the second converter 43 to the network-interface 140 may be forwarded via the coupling 158 into a network for adjusting the transfer of the audio/video signal through this network and/or at a provider. The selector 42 may alternatively form part of the second user-interface 120.

About the FIG. 1-3, the memory 21 or parts thereof may be located inside one or more of the detectors 31-33 and the generators 34-36 and the converters 41,43, and/or the memory 21 or parts thereof may be added to one or more of the circuits 3,4 and coupled to one or more of the detectors 31-33 and the generators 34-36 and the converters 41,43. Further, one or more of the detectors 31-33 and the generators 34-36 may be added to one or more of the circuits 1,3. One or more of the converters 41,43 and the selector 42 may be added to one or more of the circuits 1,2. One or more of the detectors 31-33 and the generators 34-36 and the converters 41,43 and the selector 42 may be located in and/or realized by the controller 22.

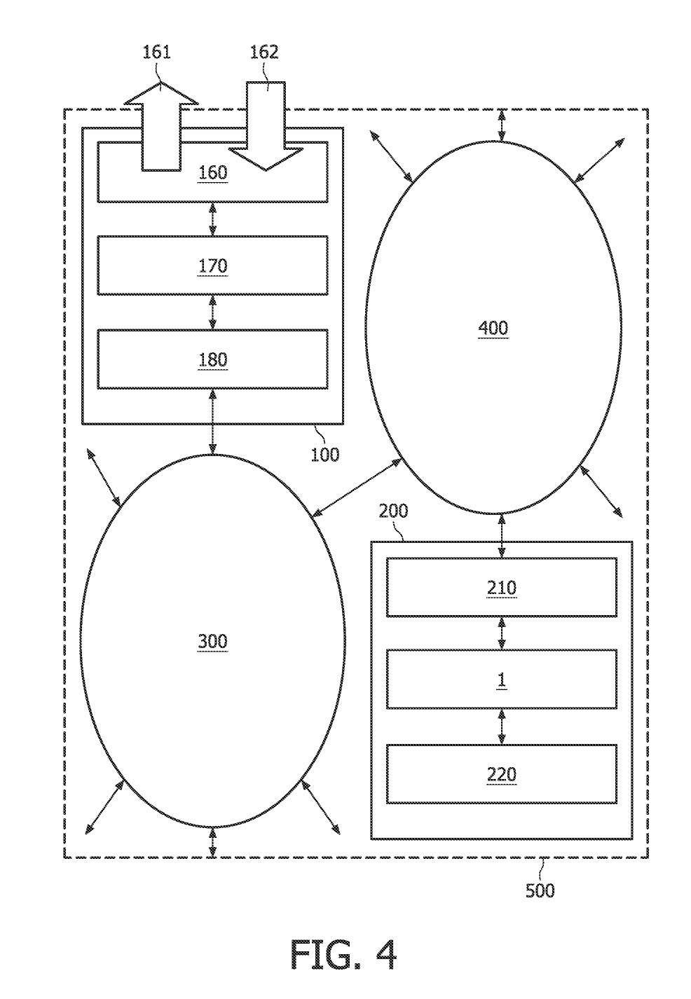

The system 500 shown in the FIG. 4 comprises a device 100 comprising a user-interface 160 for rendering an audio/video signal via one or more loudspeakers and/or one or more displays all represented by an arrow 161 and forming part of and/or coupled to the user-interface 160 and for receiving input information from a user via a keyboard, a mouse, a microphone and/or a touch-screen all represented by an arrow 162 and forming part of and/or coupled to the user-interface 160. The user-interface 160 further supplies output information to a user via one or more loudspeakers and/or one or more displays all represented by the arrow 161 and forming part of and/or coupled to the user-interface 160.

The device 100 further comprises a processor/ memory 170 coupled to the user-interface 160. The device 100 further comprises a network-interface 180 coupled to the processor/memory 170 and to a first wired and/or wireless network 300. The first wired and/or wireless network 300 is coupled to a second wired and/or wireless network 400, which is coupled to a further device 200.

The further device 200 comprises a network-interface 210 coupled to the second network 400 and to the apparatus 1 according to the invention. The apparatus 1 is further coupled to a processor/memory 220.

According to a first option, the further device 200 belongs to a provider for providing an audio/video signal to a user of the device 100, in which case this provider offers a further service by offering a link between a value of a transfer parameter of the audio/video signal and a value of a quality parameter of the second user-interface 120. In case of providing the value of the quality parameter in response to the value of the transfer parameter (a relatively low cost movie is accompanied by a relatively low quality environment, and a relatively high resolution movie is accompanied by a relatively high quality environment), either only for example a code defining a “skin” or a “look and feel” or an input property or an output property of the second user-interface 120 at a predefined quality is supplied from the further device 200 to the device 100, or for example an entire “skin” or an entire “look and feel” or an entire input property or an entire output property of the second user-interface 120 at a predefined quality is supplied from the further device 200 to the device 100. In case of defining the value of the transfer parameter in response to the value of the quality parameter (a relatively low quality environment is to be used for a relatively low cost movie, and a relatively high quality environment is to be used for a relatively high resolution movie), this value of the quality parameter is to be supplied to the further device 200.

According to a second option, the further device 200 belongs to a provider for providing a service by offering a link between a value of a transfer parameter of an audio/video signal and a value of a quality parameter of the second user-interface 120, whereby another provider which forms part of and/or is coupled to the first or second network 300,400 is responsible for providing the audio/video signal to a user of the device 100, or whereby the audio/video signal is already stored in the device 100. In case of providing the value of the quality parameter in response to the value of the transfer parameter (a relatively low cost song is accompanied by a relatively low quality environment, and a song with a relatively large bandwidth is accompanied by a relatively high quality environment), the further device 200 must receive this value of the transfer parameter, and either only for example a code defining a “skin” or a “look and feel” or an input property or an output property of the second user-interface 120 at a predefined quality is supplied from the further device 200 to the device 100, or for example an entire “skin” or an entire “look and feel” or an entire input property or an entire output property of the second user-interface 120 at a predefined quality is supplied from the further device 200 to the device 100. In case of defining the value of the transfer parameter in response to the value of the quality parameter (a relatively low quality environment is to be used for a relatively low cost song, and a relatively high quality environment is to be used for a song with a relatively large bandwidth), this value of the quality parameter is to be supplied to the further device 200.

One or more values of a transfer parameter and/or of a quality parameter may be set by any apparatus/device/user/operator/provider and independently from a location of the apparatus. Instead of an audio/video signal, a data signal such as for example a software program or an information signal may be rendered via the device, such that a first (second etc.) transfer characteristic of the data signal may result in a selection of a first (second etc.) quality characteristic of the user-interface, and a first (second etc.) quality characteristic of the user-interface may result in a selection of a first (second etc.) transfer characteristic of the data signal. Summarizing, an apparatus 1 for introducing dependencies between user-interfaces 120 of devices 100 and for example audio/video signals to be rendered via the devices 100 is provided with a circuit 2,3,4 for linking values of transfer parameters of the signals and values of quality parameters of the user-interfaces 120, to increase the user-friendliness. A given first (second) transfer of the audio/video signal results in a first (second) quality of the user-interface 120, and a chosen first (second) quality of the user-interface 120 results in a first (second) transfer of the audio/video signal. The quality may be a quality of a “skin” or a “look and feel” or an input property or an output property of the user-interface 120. The transfer may be expressed in bandwidth, resolution, number of colors or grey values, sample rate, frequency characteristic and costs. The quality may be expressed in bandwidth, resolution, number of colors or grey values, sample rate, frequency characteristic and processing capacity.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired and/or wireless telecommunication systems. Any reference signs in the claims should not be construed as limiting the scope.

1. An apparatus (1) for introducing a dependency between a user-interface (120) of a device (100) and a signal to be processed by the device (100), which apparatus (1) comprises a circuit (2,3,4) for linking a value of a transfer parameter of the signal and a value of a quality parameter of the user-interface (120).

2. An apparatus (1) as claimed in claim 1, the circuit (3) comprising a detector (31,32,33) for detecting one of the values and comprising a generator (34,35,36) for in response to a detection result generating the other one of the values.

3. An apparatus (1) as claimed in claim 1, the circuit (4) comprising a converter (41) for converting the value of the transfer parameter of the signal into the value of the quality parameter of the user-interface (120).

4. An apparatus (1) as claimed in claim 1, further comprising a port for receiving the value of the quality parameter of the user-interface (120), and the circuit (4) comprising a converter (43) for converting the value of the quality parameter of the user-interface (120) into the value of the transfer parameter of the signal.

5. An apparatus (1) as claimed in claim 1, the transfer parameter of the signal comprising at least one of a bandwidth of the signal, a resolution of the signal, a number of colors in the signal, a number of grey values in the signal, a sample rate of the signal, a frequency characteristic of the signal and a cost parameter of the signal, and the quality parameter of the user-interface (120) comprising at least one of a bandwidth of a user-interface signal of the user-interface (120), a resolution of the user-interface signal, a number of colors in the user-interface signal, a number of grey values in the user-interface signal, a sample rate of the user-interface signal, a frequency characteristic of the user-interface signal and a processing capacity available for the user-interface (120).

6. A device (100) comprising the apparatus (1) as claimed in claim 1.

7. A method for introducing a dependency between a user-interface (120) of a device (100) and a signal to be processed by the device (100), which method comprises a step of linking a value of a transfer parameter of the signal and a value of a quality parameter of the user-interface (120).

8. A computer program product for performing the step of the method as claimed in claim 7.

9. A medium for storing and comprising the computer program product as claimed in claim 8.
